(19) United States
(12) Patent Application Publication
(10) Pub. No.: US 2024/0121202 A1
(43) Pub. Date: Apr. 11, 2024

(54) TRAFFIC SCHEDULING METHOD AND APPARATUS, AND ELECTRONIC DEVICE AND COMPUTER-READABLE MEDIUM

(71) Applicant: BEIJING HUIJUN TECHNOLOGY CO., LTD., Beijing (CN)

(72) Inventors: Xuqian LI, Beijing (CN); Bin DONG, Beijing (CN); Li LI, Beijing (CN)

(73) Assignee: BEIJING HUIJUN TECHNOLOGY CO., LTD., Beijing (CN)

(21) Appl. No.: 18/546,102

(22) PCT Filed: Jan. 4, 2022
(86) PCT No.: PCT/CN2022/070069

§ 371 Date: Aug. 11, 2023

(30) Foreign Application Priority Data
Mar. 23, 2021 (CN) 202110307609.3

(51) Int. Cl. H04L 49/253

(52) U.S. Cl. CPC H04L 49/253

(57) ABSTRACT

The present disclosure relates to a traffic scheduling method and apparatus, and an electronic device and a computer-readable medium. The traffic scheduling method comprises: acquiring, by means of a traffic egress switch, a current packet to be sent, and forwarding the packet to a programmable switch, which is connected to the traffic egress switch; acquiring, by means of the programmable switch, a communication parameter corresponding to the packet, and determining a target port identifier of the packet according to the communication parameter; marking the packet according to the target port identifier of the packet, and returning the marked packet to the traffic egress switch; and determining, according to the target port identifier, a target output port corresponding to the packet from among a plurality of output ports of the traffic egress switch, and sending the packet by means of the target output port.

### CROSS-REFERENCE TO RELATED APPLICATIONS

The present disclosure claims priority to Chinese Patent Application No. 202110307609.3, filed Mar. 23, 2021, titled “TRAFFIC SCHEDULING METHOD AND APPARATUS, AND ELECTRONIC DEVICE AND COMPUTER-READABLE MEDIUM”, the entire content of which is hereby incorporated into the present disclosure for reference.

### TECHNICAL FIELD

The present disclosure relates to the field of communication technologies, and in particular, to a traffic scheduling method, a traffic scheduling apparatus, an electronic device, and a computer-readable medium.

### BACKGROUND

At present, there are two main manners of charging between the computer room outlet and the operator, namely the buyout port and the charging-by-traffic port. For these two types of charging ports, traffic is generally scheduled by evenly distributing traffic or manually maintaining the port.

However, evenly distributing traffic will lead to relatively high costs, and manual maintenance of port will result in relatively high operation and maintenance costs, waste of human resources, and low traffic scheduling efficiency.

In view of this, there is an urgent need in the art for a traffic scheduling method that can reasonably allocate traffic and reduce costs.

It should be noted that the information disclosed in the above Background section is only for enhancement of understanding of the background of the present disclosure, and therefore may contain information that does not form the prior art that is already known to a person of ordinary skill in the art.

### SUMMARY

The purpose of the present disclosure is to provide a traffic scheduling method, a traffic scheduling apparatus, an electronic device, and a computer-readable medium, so as to improve the efficiency of traffic scheduling and reduce traffic costs at least to a certain extent.

According to a first aspect of the present disclosure, a traffic scheduling method is provided, including:
acquiring a currently to-be-sent message through a traffic egress switch, and forwarding the message to a programmable switch connected to the traffic egress switch;
acquiring a communication parameter corresponding to the message through the programmable switch, and determining a target port identifier of the message according to the communication parameter;
marking the message according to the target port identifier of the message, and returning the marked message to the traffic egress switch; and
determining a target output port corresponding to the message from a plurality of output ports of the traffic egress switch according to the target port identifier, and sending the message through the target output port.

In an exemplary embodiment of the present disclosure, the communication parameter includes a current traffic value and a multivariate communication field of the message, and the determining the target port identifier of the message according to the communication parameter includes:
determining an output port type corresponding to the message according to the current traffic value and the multivariate communication field of the message;
determining the target port identifier of the message from a plurality of port tag fields included in the output port type according to the multivariate communication field of the message.

In an exemplary embodiment of the present disclosure, the determining the output port type corresponding to the message according to the current traffic value and the multivariate communication field of the message includes:
determining a flow corresponding to the message according to the multivariate communication field of the message, and acquiring a timestamp corresponding to a previous message of the flow;
acquiring a timestamp corresponding to the message, and determining a time interval between the message and the previous message according to the timestamp corresponding to the message and the timestamp corresponding to the previous message;
determining the output port type of the message according to the current traffic value and the time interval between the message and the previous message.

In an exemplary embodiment of the present disclosure, the determining the flow corresponding to the message according to the multivariate communication field of the message includes:
obtaining a hash identification code corresponding to the message according to the multivariate communication field of the message, and determining the flow corresponding to the message according to the hash identification code.

In an exemplary embodiment of the present disclosure, the determining the output port type of the message according to the current traffic value and the time interval between the message and the previous message includes:
determining whether the current traffic value is greater than a traffic limit threshold, and whether the time interval between the message and the previous message is greater than a time interval threshold;
in response to that the current traffic value is greater than the traffic limit threshold, and the time interval is greater than the time interval threshold, determining the port tag field of the message as a charging port type;
in response to that the current traffic value is less than or equal to the traffic limit threshold, and the time interval is greater than the time interval threshold, determining the port tag field of the message as a buyout port type;
in response to that the time interval is less than or equal to the time interval threshold, determining the port tag field of the message as an output port type corresponding to the previous message.

In an exemplary embodiment of the present disclosure, after determining the target output port corresponding to the message from the plurality of output ports of the traffic egress switch according to the target port identifier, the method further includes:
acquiring a current traffic value of the target output port, and determining whether the current traffic value of the target output port is less than or equal to an output port traffic threshold;
in response to that the current traffic value of the target output port is less than or equal to the output port traffic threshold, sending the message through the target output port;
in response to that the current traffic value of the target output port is greater than the output port traffic threshold, modifying the target port identifier of the message to a default port identifier, and sending the message through an output port corresponding to the default port identifier.

In an exemplary embodiment of the present disclosure, a total bandwidth of a connection between the traffic egress switch and the programmable switch is greater than a total bandwidth of all output ports in the traffic egress switch.

According to a second aspect of the present disclosure, there is provided an traffic scheduling apparatus, including:
a message acquisition module, configured to acquire a currently to-be-sent message through a traffic egress switch, and forward the message to a programmable switch connected to the traffic egress switch;
an identifier determining module, configured to acquire a communication parameter corresponding to the message through the programmable switch, and determine a target port identifier of the message according to the communication parameter;
a message marking module, configured to mark the message according to the target port identifier of the message, and return the marked message to the traffic egress switch;
a message sending module, configured to determine a target output port corresponding to the message from a plurality of output ports of the traffic egress switch according to the target port identifier, and send the message through the target output port.

According to a third aspect of the present disclosure, there is provided an electronic device, including: a processor; and a memory for storing executable instructions of the processor; where the processor is configured to execute the executable instructions to perform any one of the traffic scheduling methods described above.

According to a fourth aspect of the present disclosure, there is provided a computer-readable medium on which a computer program is stored, and when the computer program is executed by a processor, any one of the traffic scheduling methods described above is implemented.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Obviously, the drawings in the following description are only some embodiments of the present disclosure, and for those of ordinary skill in the art, other drawings can also be obtained from these drawings without creative effort.

FIG. 1 shows a schematic flowchart of a traffic scheduling method according to an exemplary embodiment of the present disclosure;

FIG. 2 shows a schematic flowchart of determining a target port identifier of a message according to a communication parameter according to an exemplary embodiment of the present disclosure;

FIG. 3 shows a schematic flowchart of determining an output port type corresponding to a message according to a current traffic value and a multivariate communication field of the message according to an exemplary embodiment of the present disclosure;

FIG. 4 shows a deployment network topology diagram according to a specific embodiment of the present disclosure;

FIG. 5 shows a schematic flowchart of a traffic scheduling method according to a specific embodiment of the present disclosure;

FIG. 6 shows a block diagram of an traffic scheduling apparatus according to an example embodiment of the present disclosure;

FIG. 7 shows a schematic structural diagram of a computer system suitable for implementing an electronic device according to an embodiment of the present disclosure.

### DETAILED DESCRIPTION

The exemplary embodiments will now be described more fully with reference to the accompanying drawings. However, the exemplary embodiments can be implemented in various forms and should not be construed as being limited to the examples set forth herein; rather, these embodiments are provided so that the present disclosure will be more comprehensive and complete, and the concepts of the exemplary embodiments will be fully conveyed to those skilled in the art. The described features, structures, or characteristics may be combined in any suitable manner in one or more embodiments. In the following description, numerous specific details are provided in order to give a thorough understanding of the embodiments of the present disclosure. However, those skilled in the art will appreciate that the technical solutions of the present disclosure may be practiced without one or more of the specific details, or other methods, components, apparatuses, steps, etc. may be adopted. In other instances, well-known technical solutions are shown or described in detail to avoid obscuring the aspects of the present disclosure.

Furthermore, the drawings are merely schematic illustrations of the present disclosure and are not necessarily drawn to scale. The same reference numerals in the drawings denote the same or similar parts, and thus their repeated descriptions will be omitted. Some of the block diagrams shown in the drawings are functional entities that do not necessarily correspond to physically or logically separate entities. These functional entities may be implemented in software, or in one or more hardware modules or integrated circuits, or in different networks and/or processor apparatuses and/or microcontroller apparatuses.

The current charging manners between the computer room outlet and the operator are as follows:

1. Buyout port: an output port with a fixed bandwidth, there is no need to count how much traffic the port actually transmits, and it is charged according to the fixed bandwidth uniformly.

2. Traffic-based charging port: an output port that is charged according to the actual traffic used.

In some related embodiments, based on the above two charging manners, in the case that the current computer room includes the above two ports, the following traffic scheduling methods can be adopted:

1. Equal Cost Multi-path (Ecmp): By calculating the quintuple hash, the traffic is evenly distributed to all ports, regardless of the charging manner of each port.

The main disadvantage of Ecmp is that it does not consider the port's charging manner, and just distributes the traffic evenly to all ports. In this way, the bandwidth of the buyout port is not fully utilized, but a lot of traffic is output from the charging port, resulting in relatively high traffic costs.

2. Manual maintenance port: according to the current real-time traffic, the ports are manually added or deleted, and the buyout port may be preferred to be used, and then the port(s) that are charged based on traffic is increased according to the real-time traffic.

By manually maintaining the currently usage of ports, the operation and maintenance cost is high, and the operations are repetitive, which will result in a waste of manpower.

3. Speed limit at the buyout port: Access Control Lists (acl) speed limit is set on the buyout port. When the current traffic is less than the speed limit, the charging is performed using the buyout port; and when it exceeds, the excess part is charged using the charging port.

By setting the speed limit on the buyout port, only the part exceeding the speed limit is allowed to go to the charging port, which will cause the same flow to be forwarded from different ports, so there is the possibility of packet loss or disorder.

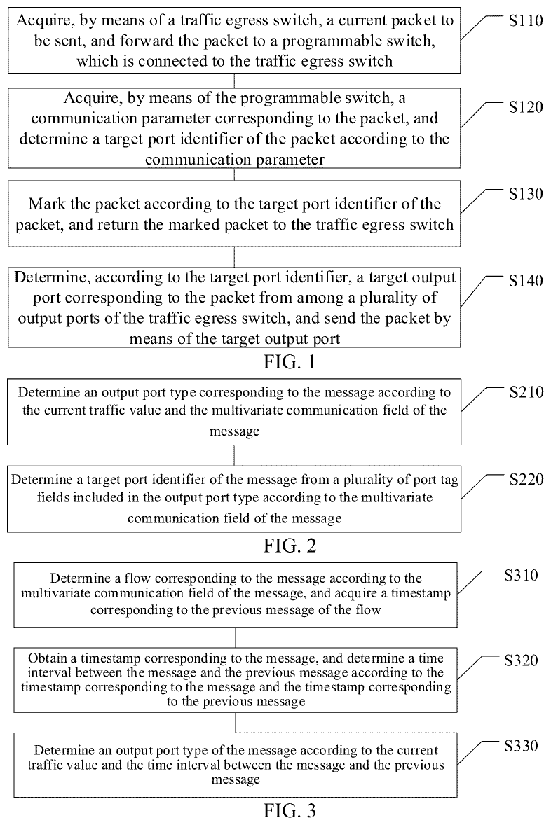

Based on the above problems, this exemplary embodiment first provides a traffic scheduling method. Referring to FIG. 1, the above traffic scheduling method may include the following steps.

In step S110, a currently to-be-sent message is acquired through a traffic egress switch, and the message is forwarded to a programmable switch connected to the traffic egress switch.

In step S120, a communication parameter corresponding to the message is acquired through the programmable switch, and a target port identifier of the message is determined according to the communication parameter.

In step S130, the message is marked according to the target port identifier of the message, and the marked message is returned to the traffic egress switch.

In step S140, a target output port corresponding to the message is determined from a plurality of output ports of the traffic egress switch according to the target port identifier, and the message is sent through the target output port.

In the traffic scheduling method according to the exemplary embodiment of the present disclosure, by forwarding the currently to-be-sent message from the traffic egress switch to the programmable switch, and marking the message by the programmable switch according to the communication parameter corresponding to the current message, the traffic is distributed to different ports reasonably according to the marked message. The traffic scheduling method in the exemplary embodiment of the present disclosure can reasonably schedule the traffic, perform statistics on the traffic through the programmable switch and allocate it to individual ports, which can reduce the operation and maintenance cost on the basis of saving the traffic cost, and improve the efficiency of traffic scheduling.

Hereinafter, the above steps of the present exemplary embodiment will be described in more detail with reference to FIGS. 2 to 6.

In step S110, a currently to-be-sent message is acquired through a traffic egress switch, and the message is forwarded to a programmable switch connected to the traffic egress switch.

The switch is a network device used for signal forwarding. In this exemplary embodiment, the traffic egress switch refers to a network device used for managing the outbound traffic of the computer room, and the inbound traffic does not pass through the traffic egress switch.

The programmable switch is a network switch with programmable capabilities that can be controlled by programming languages, such as a Programming Protocol-independent Packet Processor (P4) programmable switch controlled by P4 language.

In this exemplary embodiment, the traffic egress switch and the programmable switch may be connected by way of bypass deployment according to the total amount of egress bandwidth, where the programmable switch may be, for example, a P4 programmable switch. Specifically, when connecting the traffic egress switch and the programmable switch, the total bandwidth of the connection between the traffic egress switch and the programmable switch is greater than the total bandwidth of all output ports in the traffic egress switch. After the connection, by initiating Border Gateway Protocol (bgp) on the traffic egress switch and the programmable switch, the default route of the outbound direction of the traffic egress switch is pointed to the programmable switch, so that the egress direction of the traffic is changed from the default direction of directly entering the public network to the direction of entering the programmable switch, and the programmable switch logically processes the currently to-be-sent message.

In step S120, a communication parameter corresponding to the message is acquired through the programmable switch, and a target port identifier of the message is determined according to the communication parameter.

In this exemplary embodiment, the communication parameter of the message includes a current traffic value and a multivariate communication field of the message, where the multivariate communication field of the message may be, for example, a quadruple, a quintuple, a seven-tuple, etc., and taking the quintuple as an example, it includes five fields: a source IP, a source port, a destination IP, a destination port and the layer 4 protocol.

In this exemplary embodiment, a target port identifier of the current message may be determined according to the communication parameter of the message through the programmable switch, and the target port identifier may be used to mark the specific output port from which the message is sent.

In this exemplary embodiment, as shown in FIG. 2, determining the target port identifier of the message according to the communication parameter may specifically include the following steps.

In step S210, an output port type corresponding to the message is determined according to the current traffic value and the multivariate communication field of the message.

The output port type includes a buyout port type and a charging port type. The buyout port type refers to an output port type with a fixed bandwidth, which is charged uniformly according to the fixed bandwidth. The charging port type refers to an output port type that is charged according to the actually used traffic. Each type may include one or more corresponding output ports. For example, the buyout port type may include a first buyout output port and a second buyout output port, and the charging port type may include a first charging output port, a second charging output port, etc.

In this exemplary embodiment, as shown in FIG. 3, determining the output port type corresponding to the message according to the current traffic value and the multivariate communication field of the message may specifically include the following steps.

In step S310, a flow corresponding to the message is determined according to the multivariate communication field of the message, and a timestamp corresponding to the previous message of the flow is acquired.

In this exemplary embodiment, a hash identification code corresponding to the message can be obtained according to the multivariate communication field of the message, and the flow corresponding to the message is determined according to the hash identification code. Specifically, a hash operation may be performed on the quintuple of the message to obtain a hash id of the current message, then the flow corresponding to the message is searched for in a flowlet table entry through the hash id, and information corresponding to the previous message of this flow, including a timestamp, etc. is obtained.

In step S320, a timestamp corresponding to the message is obtained, and a time interval between the message and the previous message is determined according to the timestamp corresponding to the message and the timestamp corresponding to the previous message.

After acquiring the timestamps corresponding to the current message and the previous message, the time interval between the current message and the previous message is obtained according to the information in the two timestamps.

In step S330, an output port type of the message is determined according to the current traffic value and the time interval between the message and the previous message.

After acquiring the current traffic value and the time interval of the current message, the output port type of the message is determined by determining whether the current traffic value is greater than the traffic limit threshold, and whether the time interval between the message and the previous message is greater than the time interval threshold. Specifically, if the current traffic value is greater than the traffic limit threshold and the time interval is greater than the time interval threshold, a port tag field of the message is determined as the charging port type; if the current traffic value is less than or equal to the traffic limit threshold and the time interval is greater than the time interval threshold, the port tag field of the message is determined as the buyout port type; if the time interval is less than or equal to the time interval threshold, the port tag field of the message is determined as the output port type corresponding to the previous message.

In step S220, a target port identifier of the message is determined from a plurality of port tag fields included in the output port type according to the multivariate communication field of the message.

Each output port type may contain a plurality of output ports, which respectively correspond to a plurality of port tag fields, such as a Differentiated Services Code Point (dscp) number. After the output port type corresponding to the current message is determined, one dscp number can be determined from the plurality of port tag fields included in the output port type by performing a hash operation on the quintuple of the message, as the target port identifier of the message.

Through the programmable switch, the outlet traffic of the computer room preferentially goes to the buyout port, and when the real-time traffic value exceeds the traffic limit threshold of the buyout port, part of the flow will be switched to the charging port at the granularity of the flow. Statistics is performed on the flow at the programmable switch, the flow scheduling is realized by recording the timestamp for the flow, and the flow is assigned to different types of ports, so as to fully utilize the buyout port as much as possible, with the rest of the traffic goes to the charging port, thereby saving the network costs.

In step S130, the message is marked according to the target port identifier of the message, and the marked message is returned to the traffic egress switch.

After determining the target port identifier of the message, the target port identifier is marked on the message, and then the marked message is returned to the traffic egress switch. When returning the message, the port through which the message enters the programmable switch from the traffic egress switch is first obtained, and then the message is returned to the traffic egress switch from the port.

In step S140, a target output port corresponding to the message is determined from a plurality of output ports of the traffic egress switch according to the target port identifier, and the message is sent through the target output port.

After the traffic egress switch receives the message returned by the programmable switch, according to the carried target port identifier, such as the dscp number, it identifies the target output port corresponding to the dscp number through the pre-configured Access Control Lists (ad) on the traffic egress switch, and then forwards the message through the target output port.

In addition, in this exemplary embodiment, when the upper limit of bandwidth of the target output port corresponding to the target port identifier is reached, if the message is sent from this port, the packet loss may occur. Therefore, the current traffic value of the target output port may be acquired in advance, and then it is determined whether the current traffic value of the target output port is less than or equal to the output port traffic threshold. If the current traffic value of the target output port is less than or equal to the output port traffic threshold, the message will be sent through the target output port; if the current traffic value of the target output port is greater than the output port traffic threshold, the target port identifier of the message will be modified to a default port identifier, and the message is sent through the output port corresponding to the default port identifier.

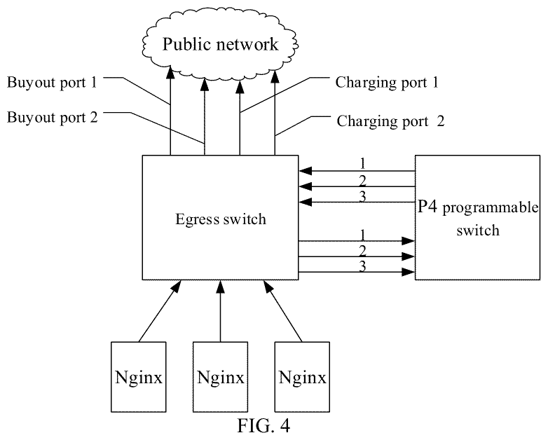

FIG. 4 is a deployment network topology diagram according to a specific embodiment of the present disclosure, which can be used to manage the outbound traffic of a computer room. As shown in FIG. 4, the p4 programmable switch is a bypass deployment, the egress switch and the p4 programmable switch are connected according to the total amount of the egress bandwidth, and the total bandwidth of the connection between the egress switch and the p4 programmable switch should be greater than the total egress bandwidth of the egress switch. Specifically, the total bandwidth of ports 1, 2, and 3 in FIG. 4 needs to be greater than the total bandwidth of port buyout 1, buyout 2, charging 1, and charging 2.

After connection, the dscp numbers need to be assigned to each output port first, and the dscp number and the acl corresponding to the port are wrote in the egress switch, so that the p4 programmable switch can determine the corresponding output port according to the dscp number. Then, by initiating bgp on the p4 programmable switch and the egress switch, the default route of the outbound direction of the egress switch is directed to the p4 programmable switch, so that the outbound traffic will go to the p4 device. After logical processing on the p4 programmable switch, each message is marked with the corresponding dscp number, and then the message is sent back to the egress switch in the original path. The egress switch selects the corresponding target output port according to the dscp number marked on the message, and forwards the message to the target output port for sending.

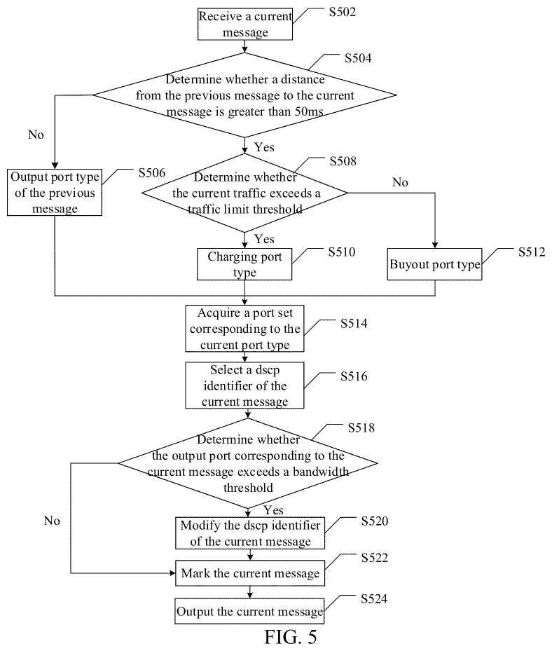

FIG. 5 is a complete flowchart of a traffic scheduling method in a specific embodiment of the present disclosure, which is an example of the above steps in this exemplary embodiment. The specific steps of the flowchart are as follows.

In step S502, a current message is received.

In step S504, it is determined whether a distance from the previous message to the current message is greater than 50 ms.

The hash operation is performed on the quintuple of the current message to obtain the hash id of the current message, and then the flow corresponding to the message is searched for in the flowlet entry through the hash id, and a timestamp corresponding to the previous message of this flow is acquired, to determine whether the distance between the previous message of this flow and the current message is greater than 50 ms. If the distance from the previous message to the current message is less than or equal to 50 ms, the process goes to step S506; if the distance from the previous message to the current message is greater than 50 ms, the process goes to step S508 to determine the traffic threshold.

In step S506, an output port type of the current message is determined as an output port type of the previous message.

In step S508, it is determined whether the current traffic exceeds a traffic limit threshold.

If the current traffic exceeds the traffic limit threshold, then the process goes to step S510; if the current traffic does not exceed the traffic limit threshold, then the process goes to step S512.

In step S510, the output port type of the current message is determined as a charging port type.

In step S512, the output port type of the current message is determined as a buyout port type.

In step S514, a port set corresponding to the current port type is acquired.

In step S516, a dscp identifier of the current message is determined from the port set.

One dscp number can be randomly selected by performing a hash operation on the quintuple of the message, as the dscp identifier of the current message.

In step S518, it is determined whether the output port corresponding to the current message exceeds a bandwidth threshold.

If the output port corresponding to the current message has reached the bandwidth threshold, then the process goes to step S520, and the dscp identifier of the current message is replaced with the dscp identifier of other port; if the output port corresponding to the current message has not reached the bandwidth threshold, the process goes to step S522.

In step S520, the dscp identifier of the current message is modified.

The dscp identifier of the current message is modified to the dscp identifier of the default port.

In step S522, the current message is marked according to the dscp identifier of the current message.

In step S524, the current message is outputted.

From which port the message enters the P4 programmable switch, it is sent back to the egress switch from which port. For example, if the message enters the P4 programmable switch from port 1 in FIG. 4, it returns to the egress switch from port 1 when returning.

After receiving the message, the egress switch identifies the physical port corresponding to the dscp number through the pre-configured ad, and forwards the message through this physical port.

The traffic scheduling method in this exemplary implementation can also be implemented by an x86 server. However, since the architecture of the server cannot meet the T-level bandwidth and small packet wire-speed processing capability, and it is difficult to process a large number of messages in milliseconds, the development cost and equipment costs are relatively high.

It should be noted that although the various steps of the methods in the present disclosure are depicted in the drawings in a particular order, this does not require or imply that the steps must be performed in that particular order, or that all illustrated steps must be performed to achieve the desired result. Additionally or alternatively, certain steps may be omitted, multiple steps may be combined into one step for execution, and/or one step may be decomposed into multiple steps for execution, and the like.

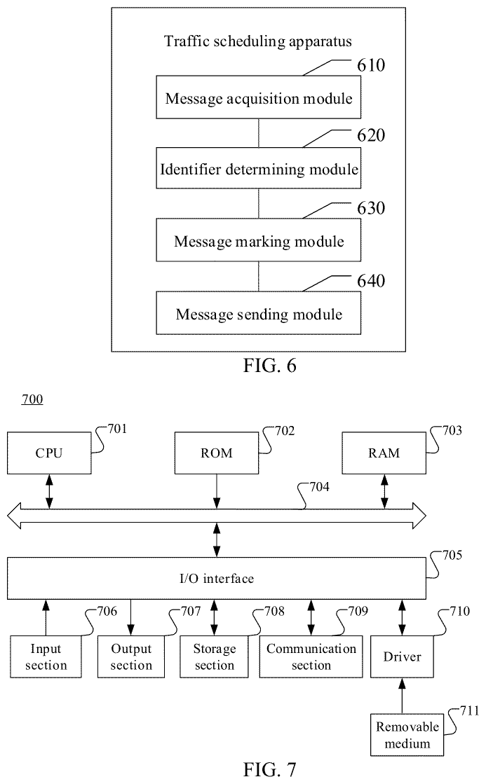

Further, the present disclosure also provides a traffic scheduling apparatus. Referring to FIG. 6, the traffic scheduling apparatus may include a message acquisition module 610, an identifier determining module 620, a message marking module 630 and a message sending module 640.

The message acquisition module 610 is configured to acquire a currently to-be-sent message through a traffic egress switch, and forward the message to a programmable switch connected to the traffic egress switch.

The identifier determining module 620 is configured to acquire a communication parameter corresponding to the message through the programmable switch, and determine a target port identifier of the message according to the communication parameter.

The message marking module 630 is configured to mark the message according to the target port identifier of the message, and return the marked message to the traffic egress switch.

The message sending module 640 is configured to determine a target output port corresponding to the message from a plurality of output ports of the traffic egress switch according to the target port identifier, and send the message through the target output port.

In some exemplary embodiments of the present disclosure, the identifier determining module 620 may include an output port type determining unit and a target port identifier determining unit.

The output port type determining unit is configured to determine an output port type corresponding to the message according to a current traffic value and a multivariate communication field of the message.

The target port identifier determining unit is configured to determine a target port identifier of the message from a plurality of port tag fields included in the output port type according to the multivariate communication field of the message.

In some exemplary embodiments of the present disclosure, the output port type determining unit may include a timestamp acquisition unit, a time interval determining unit, and a port type determining unit.

The timestamp acquisition unit is configured to determine a flow corresponding to the message according to the multivariate communication field of the message, and acquire a timestamp corresponding to a previous message of the flow.

The time interval determining unit is configured to acquire a timestamp corresponding to the message, and determine a time interval between the message and the previous message according to the timestamp corresponding to the message and the timestamp corresponding to the previous message.

The port type determining unit is configured to determine an output port type of the message according to the current traffic value and the time interval between the message and the previous message.

In some exemplary embodiments of the present disclosure, the timestamp acquisition unit may include a hash identification code determining unit, configured to obtain a hash identification code corresponding to the message according to the multivariate communication field of the message, and determine a flow corresponding to the message according to the hash identification code.

In some exemplary embodiments of the present disclosure, the port type determining unit may include a parameter threshold determining unit, a charging port type determining unit, a buyout port type determining unit, and a historical port type determining unit.

The parameter threshold determining unit is configured to determine whether the current traffic value is greater than the traffic limit threshold, and whether the time interval between the message and the previous message is greater than a time interval threshold.

The charging port type determining unit is configured to determine the port tag field of the message as the charging port type if the current traffic value is greater than the traffic limit threshold and the time interval is greater than the time interval threshold.

The buyout port type determining unit is configured to determine the port tag field of the message as the buyout port type if the current traffic value is less than or equal to the traffic limit threshold and the time interval is greater than the time interval threshold.

The historical port type determining unit is configured to determine the port tag field of the message as the output port type corresponding to the previous message if the time interval is less than or equal to the time interval threshold.

In some exemplary embodiments of the present disclosure, the traffic scheduling apparatus provided by the present disclosure may further include an output port traffic limiting module, and the output port traffic limiting module may include a port traffic threshold determining unit, an output port message sending unit, and a default port message sending unit.

The port traffic threshold determining unit is configured to acquire a current traffic value of the target output port, and determine whether the current traffic value of the target output port is less than or equal to an output port traffic threshold.

The output port message sending unit is configured to send the message through the target output port if the current traffic value of the target output port is less than or equal to the output port traffic threshold.

The default port message sending unit is configured to, if the current traffic value of the target output port is greater than the output port traffic threshold, modify the target port identifier of the message to a default port identification, and send the message through an output port corresponding to the default port identification.

The specific details of each module/unit in the above-mentioned traffic scheduling apparatus have been described in detail in the corresponding method embodiment section, and will not be repeated here.

FIG. 7 shows a schematic structural diagram of a computer system suitable for implementing an electronic device of an embodiment of the present disclosure.

It should be noted that the computer system 700 of the electronic device shown in FIG. 7 is only an example, and should not impose any limitations on the functions and scope of use of the embodiments of the present disclosure.

As shown in FIG. 7, the computer system 700 includes a central processing unit (CPU) 701 which can perform various appropriate actions and processes according to the program stored in a read only memory (ROM) 702 or a program loaded into a random access memory (RAM) 703 from a storage section 708. In the RAM 703, various programs and data required for system operation are also stored. The CPU 701, the ROM 702, and the RAM 703 are connected to each other through a bus 704. An input/output (I/O) interface 705 is also connected to the bus 704.

The following components are connected to the I/O interface 705: an input section 706 including a keyboard, a mouse, etc.; an output section 707 including a cathode ray tube (CRT), a liquid crystal display (LCD), and a speaker, etc.; a storage section 708 including a hard disk, etc.; and a communication section 709 including a network interface card such as a LAN card, a modem, and the like. The communication section 709 performs communication processing via a network such as the Internet. A drive 710 is also connected to the I/O interface 705 as needed. A removable medium 711, such as a magnetic disk, an optical disk, a magneto-optical disk, a semiconductor memory, etc., is mounted on the drive 710 as needed so that a computer program read therefrom is installed into the storage section 708 as needed.

In particular, according to the embodiments of the present disclosure, the processes described below with reference to the flowcharts may be implemented as computer software programs. For example, the embodiments of the present disclosure include a computer program product including a computer program carried on a computer-readable medium, the computer program containing a program code for performing the methods illustrated in the flowcharts. In such an embodiment, the computer program may be downloaded and installed from the network via the communication portion 709 and/or installed from the removable medium 711. When the computer program is executed by the central processing unit (CPU) 701, various functions defined in the system of the present disclosure are executed.

It should be noted that the computer-readable medium shown in the present disclosure may be a computer-readable signal medium, or a computer-readable storage medium, or any combination of the above two. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but are not limited to, an electrical connection with one or more wires, a portable computer disk, a hard disk, a random access memory (RAM), a read only memory (ROM), an erasable Programmable read only memory (EPROM or flash memory), an optical fiber, a portable compact disk read only memory (CD-ROM), an optical storage device, a magnetic storage device, or any suitable combination of the above. In the present disclosure, the computer-readable storage medium may be any tangible medium that contains or stores a program, and the program can be used by or in conjunction with an instruction execution system, apparatus, or device. In the present disclosure, the computer-readable signal medium may include a data signal propagated in baseband or as part of a carrier wave, carrying computer-readable program codes therein. Such propagated data signals may take a variety of forms, including but not limited to electromagnetic signals, optical signals, or any suitable combination of the foregoing. The computer-readable signal medium may also be any computer-readable medium other than the computer-readable storage medium that can send, propagate, or transmit the program for use by or in connection with the instruction execution system, apparatus, or device. The program code embodied on the computer-readable medium may be transmitted using any suitable medium including, but not limited to, wireless, wireline, optical fiber cable, RF, etc., or any suitable combination of the foregoing.

The flowcharts and the block diagrams in the drawings illustrate the system architecture, function, and operation of possible implementations of systems, methods and computer program products according to various embodiments of the present disclosure. In this regard, each block in the flowcharts or block diagrams may represent one module, segment, or portion of code that contains one or more executable instructions for implementing the specified logical functions. It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending upon the function involved. It is also noted that each block in the block diagrams or flowcharts, and combinations of blocks in the block diagrams or flowcharts, may be implemented by special purpose hardware-based systems that perform the specified functions or operations, or may be implemented using a combination of dedicated hardware and computer instructions.

On the other hand, the present disclosure also provides a computer-readable medium, which may be included in the electronic device described in the above embodiments; or it may exist alone without being assembled into the electronic device. The above computer-readable medium carries one or more programs. When the one or more programs are executed by one electronic device, the electronic device implements the methods described in the following embodiments.

It should be noted that although several modules of the device for performing actions are mentioned in the above detailed description, this division is not mandatory. Indeed, in accordance with the embodiments of the present disclosure, the features and functions of two or more modules described above may be embodied in one module. Conversely, the features and functions of one module described above may be further subdivided to be embodied by a plurality of modules.

Other embodiments of the present disclosure will readily occur to those skilled in the art upon consideration of the specification and practice of the present application disclosed herein. The present disclosure is intended to cover any variations, uses, or adaptations of the present disclosure that follow the general principles of the present disclosure and include common knowledge or habitual technical means in the technical field not disclosed by the present disclosure.

It is to be understood that the present disclosure is not limited to the precise structures described above and illustrated in the accompanying drawings, and that various modifications and changes may be made without departing from the scope thereof. The scope of the present disclosure is limited only by the appended claims.

1. A traffic scheduling method, comprising:
acquiring a currently to-be-sent message through a traffic egress switch, and forwarding the message to a programmable switch connected to the traffic egress switch;
acquiring a communication parameter corresponding to the message through the programmable switch, and determining a target port identifier of the message according to the communication parameter;
marking the message according to the target port identifier of the message, and returning the marked message to the traffic egress switch; and
determining a target output port corresponding to the message from a plurality of output ports of the traffic egress switch according to the target port identifier, and sending the message through the target output port.

2. The traffic scheduling method according to claim 1, wherein the communication parameter comprises a current traffic value and a multivariate communication field of the message, and the determining the target port identifier of the message according to the communication parameter comprises:
determining an output port type corresponding to the message according to the current traffic value and the multivariate communication field of the message;
determining the target port identifier of the message from a plurality of port tag fields comprised in the output port type according to the multivariate communication field of the message.

3. The traffic scheduling method according to claim 2, wherein the determining the output port type corresponding to the message according to the current traffic value and the multivariate communication field of the message comprises:
determining a flow corresponding to the message according to the multivariate communication field of the message, and acquiring a timestamp corresponding to a previous message of the flow;
acquiring a timestamp corresponding to the message, and determining a time interval between the message and the previous message according to the timestamp corresponding to the message and the timestamp corresponding to the previous message;
determining the output port type of the message according to the current traffic value and the time interval between the message and the previous message.

4. The traffic scheduling method according to claim 3, wherein the determining the flow corresponding to the message according to the multivariate communication field of the message comprises:
obtaining a hash identification code corresponding to the message according to the multivariate communication field of the message, and determining the flow corresponding to the message according to the hash identification code.

5. The traffic scheduling method according to claim 3, wherein the determining the output port type of the message according to the current traffic value and the time interval between the message and the previous message comprises:
determining whether the current traffic value is greater than a traffic limit threshold, and whether the time interval between the message and the previous message is greater than a time interval threshold;
in response to that the current traffic value is greater than the traffic limit threshold, and the time interval is greater than the time interval threshold, determining the port tag field of the message as a charging port type;
in response to that the current traffic value is less than or equal to the traffic limit threshold, and the time interval is greater than the time interval threshold, determining the port tag field of the message as a buyout port type;
in response to that the time interval is less than or equal to the time interval threshold, determining the port tag field of the message as an output port type corresponding to the previous message.

6. The traffic scheduling method according to claim 1, wherein after determining the target output port corresponding to the message from the plurality of output ports of the traffic egress switch according to the target port identifier, the method further comprises:
acquiring a current traffic value of the target output port, and determining whether the current traffic value of the target output port is less than or equal to an output port traffic threshold;
in response to that the current traffic value of the target output port is less than or equal to the output port traffic threshold, sending the message through the target output port;
in response to that the current traffic value of the target output port is greater than the output port traffic threshold, modifying the target port identifier of the message to a default port identifier, and sending the message through an output port corresponding to the default port identifier.

7. The traffic scheduling method according to claim 1, wherein a total bandwidth of a connection between the traffic egress switch and the programmable switch is greater than a total bandwidth of all output ports in the traffic egress switch.

8. (canceled)

9. An electronic device, comprising:
a processor; and
a memory for storing one or more programs, wherein when the one or more programs are executed by the processor, causing the processor to implement;
acquiring a currently to-be-sent message through a traffic egress switch, and forwarding the message to a programmable switch connected to the traffic egress switch;
acquiring a communication parameter corresponding to the message through the programmable switch, and determining a target port identifier of the message according to the communication parameter;
marking the message according to the target port identifier of the message, and returning the marked message to the traffic egress switch; and
determining a target output port corresponding to the message from a plurality of output ports of the traffic egress switch according to the target port identifier, and sending the message through the target output port.

10. A computer-readable medium on which a computer program is stored, wherein when the program is executed by a processor, the program implements:
acquiring a currently to-be-sent message through a traffic egress switch, and forwarding the message to a programmable switch connected to the traffic egress switch;
acquiring a communication parameter corresponding to the message through the programmable switch, and determining a target port identifier of the message according to the communication parameter;
marking the message according to the target port identifier of the message, and returning the marked message to the traffic egress switch; and
determining a target output port corresponding to the message from a plurality of output ports of the traffic egress switch according to the target port identifier, and sending the message through the target output port.

11. The electronic device according to claim 9, wherein the communication parameter comprises a current traffic value and a multivariate communication field of the message, and the processor is further configured to:
determine an output port type corresponding to the message according to the current traffic value and the multivariate communication field of the message;
determine the target port identifier of the message from a plurality of port tag fields comprised in the output port type according to the multivariate communication field of the message.

12. The electronic device according to claim 10, wherein the processor is further configured to:
determine a flow corresponding to the message according to the multivariate communication field of the message, and acquire a timestamp corresponding to a previous message of the flow;
acquire a timestamp corresponding to the message, and determine a time interval between the message and the previous message according to the timestamp corresponding to the message and the timestamp corresponding to the previous message;
determine the output port type of the message according to the current traffic value and the time interval between the message and the previous message.

13. The electronic device according to claim 11, wherein the processor is further configured to:
obtain a hash identification code corresponding to the message according to the multivariate communication field of the message, and determine the flow corresponding to the message according to the hash identification code.

14. The electronic device according to claim 11, wherein the processor is further configured to:
determine whether the current traffic value is greater than a traffic limit threshold, and whether the time interval between the message and the previous message is greater than a time interval threshold;
in response to that the current traffic value is greater than the traffic limit threshold, and the time interval is greater than the time interval threshold, determine the port tag field of the message as a charging port type;
in response to that the current traffic value is less than or equal to the traffic limit threshold, and the time interval is greater than the time interval threshold, determine the port tag field of the message as a buyout port type;
in response to that the time interval is less than or equal to the time interval threshold, determine the port tag field of the message as an output port type corresponding to the previous message.

15. The electronic device according to claim 9, wherein after determining the target output port corresponding to the message from the plurality of output ports of the traffic egress switch according to the target port identifier, the processor is further configured to:
acquire a current traffic value of the target output port, and determine whether the current traffic value of the target output port is less than or equal to an output port traffic threshold;
in response to that the current traffic value of the target output port is less than or equal to the output port traffic threshold, send the message through the target output port;
in response to that the current traffic value of the target output port is greater than the output port traffic threshold, modify the target port identifier of the message to a default port identifier, and send the message through an output port corresponding to the default port identifier.

16. The electronic device according to claim 9, wherein a total bandwidth of a connection between the traffic egress switch and the programmable switch is greater than a total bandwidth of all output ports in the traffic egress switch.

17. The computer-readable medium according to claim 10, wherein the communication parameter comprises a current traffic value and a multivariate communication field of the message, and the processor is further configured to:
determine an output port type corresponding to the message according to the current traffic value and the multivariate communication field of the message;
determine the target port identifier of the message from a plurality of port tag fields comprised in the output port type according to the multivariate communication field of the message.

18. The computer-readable medium according to claim 11, wherein the processor is further configured to:
determine a flow corresponding to the message according to the multivariate communication field of the message, and acquire a timestamp corresponding to a previous message of the flow;
acquire a timestamp corresponding to the message, and determine a time interval between the message and the previous message according to the timestamp corresponding to the message and the timestamp corresponding to the previous message;
determine the output port type of the message according to the current traffic value and the time interval between the message and the previous message.

19. The computer-readable medium according to claim 12, wherein the processor is further configured to:
obtain a hash identification code corresponding to the message according to the multivariate communication field of the message, and determine the flow corresponding to the message according to the hash identification code.

20. The computer-readable medium according to claim 12, wherein the processor is further configured to:
determine whether the current traffic value is greater than a traffic limit threshold, and whether the time interval between the message and the previous message is greater than a time interval threshold;
in response to that the current traffic value is greater than the traffic limit threshold, and the time interval is greater than the time interval threshold, determine the port tag field of the message as a charging port type;
in response to that the current traffic value is less than or equal to the traffic limit threshold, and the time interval is greater than the time interval threshold, determine the port tag field of the message as a buyout port type;
in response to that the time interval is less than or equal to the time interval threshold, determine the port tag field of the message as an output port type corresponding to the previous message.

21. The computer-readable medium according to claim 10, wherein after determining the target output port corresponding to the message from the plurality of output ports of the traffic egress switch according to the target port identifier, the processor is further configured to:
acquire a current traffic value of the target output port, and determine whether the current traffic value of the target output port is less than or equal to an output port traffic threshold;
in response to that the current traffic value of the target output port is less than or equal to the output port traffic threshold, send the message through the target output port;
in response to that the current traffic value of the target output port is greater than the output port traffic threshold, modify the target port identifier of the message to a default port identifier, and send the message through an output port corresponding to the default port identifier.
